(19) United States
(12) Patent Application Publication
(10) Pub. No.: US 2011/0067711 A1
(43) Pub. Date: Mar. 24, 2011

(54) NIGHT TIME DENTAL PROTECTOR

(75) Inventors: John M. Jansheski, Knoxville, TN (US); Marco Wo, Providence, RI (US); Daniel Nelsen, Warwick, RI (US); Ronald W. Spencer, Knoxville, TN (US)

(73) Assignee: DenTek Oral Care Inc., Maryville, TN (US)

(21) Appl. No.: 12/565,107

(22) Filed: Sep. 23, 2009

(51) Int. Cl. A61C 5/14; B23P 17/04

(52) U.S. Cl. 128/861; 29/428

(57) ABSTRACT

A dental appliance for preventing the teeth grinding associated with bruxism that includes a bite tray having opposing first and second posterior sections for positioning between upper and lower posterior teeth of the wearer and an anterior section disposed between the first and second posterior sections. The posterior sections can include a concave curvilinear surface, a convex curvilinear surface, and a tangential portion disposed between the concave curvilinear surface and the convex curvilinear surface that is adapted to reflect the curve of Wilson as found in a prevalent occlusal alignment.

### TECHNICAL FIELD

This invention relates to the field of dental appliances. More particularly, this invention relates to a dental guard for prevention of the grinding of teeth associated with bruxism.

### BACKGROUND

Bruxism is clenching and/or grinding of the teeth caused by the activation of a reflex chewing activity. Bruxism can cause chips and cracks in the teeth and wear of the biting surface. Bruxism typically occurs during sleep.

In a typical bruxism case, the canines and incisors move laterally against each other, thereby causing abrasion of tooth enamel, removal of the sharp biting surfaces, and flattening of the edges of the teeth. Sometimes, there is a tendency to grind the molars together, which can be loud enough to wake a sleeping partner. In many cases, even when the user grinds their anterior and posterior teeth, the first teeth that are damaged or worn down are the lower anterior teeth of the user. This is because the anterior teeth are designed to tear or rip food, but not to withstand vertical loads. In contrast, molars, which are designed to grind food, are much more likely to be able to withstand vertical loads exerted during teeth grinding. This means that merely providing a physical barrier between the upper and lower anterior teeth does not adequately protect a wearer's anterior teeth because the lower anterior teeth continue to be exposed to significant vertical load pressure that causes the anterior teeth to crack and fracture. In addition, a physical barrier fails to prevent the contact pressure exerted between the upper and lower anterior teeth that can also continue to exacerbate bone structure, joint, and muscle trauma. Often, dental guards that provide a simple physical barrier fail to accommodate the anatomic curvature of the mandible and maxilla geometries, also known as the curve of Spee (FIG. 1b), and also fail to accommodate the anatomic curvature of the occlusal alignment of the wearer's teeth, also known as the curve of Wilson (FIG. 1a). The failure to accommodate the curve of Wilson and the curve of Spee can result in ill-fitting dental guards.

In some cases of bruxism, clenching occurs without significant lateral jaw movement. Clenching can, however, cause pain and injury to the wearer's muscles of mastication even if the wearer's teeth are unaffected. This is sometimes referred to as temporomandibular joint disorder (TMJD, TMJ, TMD, or TMJ syndrome), which broadly covers acute or chronic inflammation of the temporomandibular joint.

Dental guards for preventing bruxism must be used consistently for ultimate efficacy. Only consistent, daily use of the guard ensures the efficacy necessary to protect the wearer's teeth from the long-term traumatic effects of teeth grinding and bruxism. Bruxism sufferers are less likely to use their guards to treat the problem during sleep because of discomfort associated with ill-fitting prior guards. For most customized dental guards, if the guard does not comfortably fit in the wearer's mouth, it is often because the initial registration of the wearer's teeth did not capture the correct anatomical alignment of the wearer's teeth and/or the dental guard does not reflect the curve of Wilson or the curve of Spee. Improper registration can cause minimal to significant discomfort whenever the user wears the dental guard, resulting in periodic or infrequent use of the dental appliance.

What is needed is a custom-fitted dental guard to prevent bruxism that predictably generates an anatomically correct registration of the user's teeth in the dental guard, while also reflecting the curve of Wilson and the curve of Spee. This would make the dental guard more comfortable and thereby increase the likelihood of consistent, overnight use and provide improved protection of the user's teeth.

### SUMMARY OF THE INVENTION

The foregoing and other objects, aspects, features, and advantages of the invention will become more apparent from the following description and from the claims.

In one aspect of the present invention, the invention features a dental appliance that includes a bite tray and a formable portion disposed within the bite tray. In some embodiments, the bite tray can include opposing first and second posterior sections for positioning between upper and lower posterior teeth of the wearer. The anterior section of the bite tray can be disposed between the first posterior section and the second posterior section and the anterior tray section can have an arcuate curvature substantially matching a curvature of a dental arch and a bite surface that forms a tapered cross sectional contour with a buccal tray edge. In some embodiments, the buccal edge is adjacent the bite surface and disposed at an angle of less than 90 degrees to form a valley in the anterior section of the bite tray. The buccal wall or buccal edge can also be known as the facial wall.

In another aspect of the present invention, the invention features a dental appliance that includes a bite tray and a formable portion disposed within the bite tray. In some embodiments, the formable portion can include opposing first and second posterior sections for positioning between upper and lower posterior teeth of a wearer and an anterior section disposed between the first posterior section and the second posterior section, the anterior section having an arcuate curvature substantially matching a curvature of a dental arch and having a formable bite surface inclined from a lingual edge towards a buccal edge.

In a further aspect of the invention, the invention features a dental appliance that includes a bite tray and a formable portion disposed within the bite tray. In some embodiments the formable portion includes an opposing first and second posterior formable sections for positioning between upper and lower posterior teeth and an anterior section disposed between the first posterior section and the second posterior section. The posterior formable sections can have a formable bite surface for contact with upper teeth of the wearer; the formable bite surface of the posterior sections can have a concave contour.

In another aspect of the invention, the invention can feature a method of manufacturing a dental appliance. The method can include forming a bite tray and a formable portion that is disposed within the bite tray. The bite tray can have opposing first and second posterior sections for positioning between upper and lower posterior teeth of the wearer and an anterior section disposed between the first posterior section and the second posterior section. The method can also include forming the anterior section such that the anterior section can include a bottom edge that forms a tapered cross sectional contour with a buccal edge of the anterior section.

A further aspect of the invention can include a dental appliance that includes a bite tray. The bite tray can include opposing first and second posterior sections for positioning between upper and lower posterior teeth of the wearer. The posterior sections can include a concave curvilinear surface, a convex curvilinear surface, and a tangential portion disposed between the concave curvilinear surface and the convex curvilinear surface. The dental appliance can also have an anterior section disposed between the first posterior section and the second posterior section.

In another aspect of the invention, the invention can feature a dental appliance having a bite tray. The bite tray can include a bite surface adapted to contact upper teeth of a wearer. The dental appliance can also include a formable portion disposed within the bite tray and adapted to register lower teeth of a wearer. The formable portion can include opposing first and second posterior formable sections for positioning between upper and lower posterior teeth. In some embodiments, the posterior formable sections can have a formable bite surface with a concave contour.

In one aspect of the invention, the invention includes a method of manufacturing a dental appliance. The method can include forming a bite tray having opposing first and second posterior sections for positioning between upper and lower posterior teeth of the wearer and an anterior section disposed between the first posterior section and the second posterior section. The method can also include forming a dental appliance wherein the posterior sections can have a concave curvilinear surface, a convex curvilinear surface, and a tangential portion between the concave and convex surfaces.

In another aspect of the invention, the invention includes a dental appliance that includes a bite tray with opposing first and second posterior sections for positioning between upper and lower posterior teeth of the wearer. The dental appliance can also include an anterior section between the first posterior section and the second posterior section which can have a removable anterior edge.

Any of the aspects above can have one or more of the following features. The dental appliance can be adapted to register the upper or lower teeth of the wearer. The dental appliance can include a formable portion disposed adjacent the bite tray. The formable portion can be adapted to register the lower teeth of a wearer and the bite tray can be adapted to contact upper teeth of the wearer. In some embodiments, the anterior section can be adapted to prevent upper anterior teeth of the wearer from traumatically contacting the bite tray.

Any of the aspects above can include one or more of the following features. The bite tray can be adapted to accommodate the curve of Wilson. The bite tray can also be adapted to commodate the curve of Spee.

The aspects above can also include one or more of the following features. The formable portion can be disposed adjacent the first and second posterior sections of the bite tray. In some embodiments, the formable portion is only located adjacent the posterior sections of the bite tray and the formable portion is not located adjacent the anterior section of the bite tray. The formable portion can include a formable bite surface, the formable bite surface can have a concave curvature to the surface. The posterior sections of the formable portion can include a buccal edge thickness and a lingual edge thickness. The buccal edge thickness can be greater than the lingual edge thickness. In some embodiments, the concave curvature of the formable bite surface can be adapted to align a buccal cusp of a lower posterior tooth with a centerline of the formable bite surface. The formable bite surface can be configured to adapt to a lingual inclination of the lower posterior teeth. The bite surface can be configured to adapt to a buccal inclination of the upper posterior teeth.

The aspects above can also include one or more of the following features. The step of forming the dental appliance can also include forming a formable portion within the bite tray. The formable portion can also be formed to have a concave curvature. In some embodiments, the formable bite surface can have a concave surface. The formable portion can also be formed to include a lingual edge and a buccal edge, wherein the buccal edge is thicker than the lingual edge.

Any of the aspects above can include one or more of the following features. The dental appliance can include a bite tray that includes opposing first and second posterior tray sections for positioning between the upper and lower posterior teeth of the wearer and an anterior tray section disposed between the first posterior tray section and the second posterior tray section. The bite tray can also include an anterior tray section that can have an arcuate curvature substantially matching a curvature of a dental arch and a bite surface that forms a tapered cross sectional contour with a buccal tray edge. In some embodiments the anterior section of the bite tray can have a cross sectional profile to reflect a prevalent occlusal alignment of the upper and/or lower teeth. The bite tray can also be adapted to reflect a prevalent curvature of the maxilla and/or mandibles. In some embodiments the anterior section of the bite tray can be formed such that the lower anterior teeth of the wearer are substantially prevented from contacting the bite surface of the anterior section of the bite tray. In some embodiments the anterior section substantially prevents all contact, or substantially prevents damaging contact between the upper and lower anterior teeth. In some embodiments, the anterior section can also substantially prevent any traumatic contact between the bite surfaces of the upper and lower teeth. In some embodiments the anterior section substantially prevents traumatic contact between the upper and lower anterior teeth. The anterior section can also be adapted in some embodiments to distribute a load between the upper teeth and lower teeth away from the anterior teeth of the wearer and toward the posterior teeth of the wearer. In some embodiments the anterior section is formed with a tapered cross sectional contour. In some embodiments the bite tray and the buccal edge of the anterior section are disposed to form a valley. The valley can be tapered or U-shaped. In some embodiments the surface or sides of the valley are curvilinear. In some embodiments, the valley can be formed such that at least a part of the valley is formed to reflect the glenoid fossa. In some embodiments, the bite surface is a contoured shape to accommodate the teeth of the opposing arch. The bite tray can also be formed to incorporate the curve of Wilson and the curve of Spee. The bite tray can also reflect a prevalent curvature of the maxilla and/or the mandible. The bite tray can be formed to reflect a prevalent curvature of the maxilla when the dental appliance is configured to register the upper teeth and the bite tray can be formed to reflect a prevalent curvature of the mandible when the dental appliance is configured to register the lower teeth. In some embodiments, the anterior section of the bite tray is formed to reflect the prevalent shape of the glenoid fossa.

Any of the aspects above can also include one or more of the following features. The formable portion can further include opposing first and second posterior sections for positioning between the upper and lower posterior teeth of the wearer, and an anterior section disposed between the first posterior section and the second posterior section. The anterior section of the formable portion can include an arcuate curvature substantially matching the curvature of the dental arch.

Any of the aspects above can also include one or more of the following features. In some embodiments, the formable portion can include a formable bite surface which contacts the upper teeth of the wearer. In some embodiments, the formable bite surface of the anterior section of the formable portion can be inclined from the lingual edge towards the buccal edge of the formable portion. In some embodiments, the dental appliance can include a formable bite surface that can be adapted such that the upper posterior teeth of the wearer contact the first and second posterior sections before the anterior teeth of the wearer contact the anterior section when the appliance is being fitted. The formable portion can also be formed to incorporate the curve of Wilson and/or the curve of Spee. The formable portion can reflect the anatomical curvature of a prevalent occlusal relationship.

Any of the aspects above can also include one or more of the following features. The posterior sections of the formable portion can have a formable bite surface for contact with the upper teeth of the wearer, the formable bite surface can be formed with a concave curved surface. In some embodiments the concave contour of the formable bite surface is adapted to align the dental appliance with an occlusal alignment of the upper teeth or lower teeth. In some embodiments the concave contour of the formable bite surface is configured to adapt to a buccal inclination of the upper posterior teeth. The concave contour can also be adapted to a lingual inclination of the lower posterior teeth. In some embodiments the formable bite surface can be formed such that a lingual edge of the first and second posterior sections is thicker than a buccal edge of the first and second posterior sections. The formable portion can also be formed such that a buccal edge of the first and second posterior section is thicker than a lingual edge of the first and second posterior sections.

Any of the aspects above can further include one or more of the following features. In some embodiments the shape of the formable portion is moldable when the dental appliance is heated to a forming temperature and the bite tray substantially retains its shape at the forming temperature.

Any of the aspects above can include one or more of the following features. The anterior section of the bite tray can include a removable anterior section. The removable anterior edge can be adapted to retain lower anterior teeth of a user during fitting of the dental appliance. In some embodiments, the removable anterior edge can be removed before or after the fitting of the dental appliance.

The design of the bite tray and the formable portion is advantageously designed to provide substantially true alignment with the bite registration of the wearer upon molding. An additional advantage of the claimed dental guard is that the contoured shape of the anterior section of the dental guard provides a complete physical barrier between the upper and lower anterior teeth, while also preventing traumatic occlusion of the upper and lower anterior teeth.

### BRIEF DESCRIPTION OF THE DRAWINGS

FIG. 1a shows the anatomical alignment of teeth including the curve of Wilson.

FIG. 1b shows the anatomical alignment of teeth including the curve of Spee.

FIG. 2 shows an embodiment of an upper dental appliance that includes a bite tray and a formable portion.

FIG. 3 shows a rear view of an embodiment of the dental appliance.

FIG. 4a and FIG. 4b show cross sectional views of the bite tray of the dental appliance.

FIG. 5a and FIG. 5b show cross sectional views of the dental appliance.

FIG. 6 shows an embodiment of a lower dental appliance configured to register the bottom teeth of the user.

FIG. 7 shows a front view of an embodiment of a lower dental appliance.

FIG. 8a shows a bottom view of an embodiment of a lower dental appliance.

FIG. 8b shows a side view of from the lingual perspective of a lower dental appliance.

FIG. 9 shows a rear view cut away of a posterior section of a lower dental appliance.

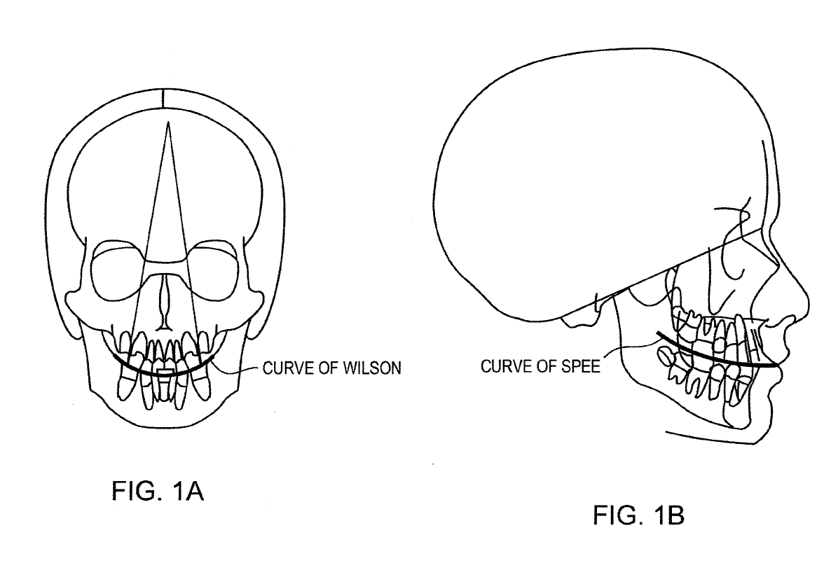

Similar numbers refer to similar parts throughout the drawings.

### DETAILED DESCRIPTION

The present invention is directed to a custom-fit dental appliance that can be used by individuals who suffer from bruxism or other disorders for which the use of a dental guard is useful.

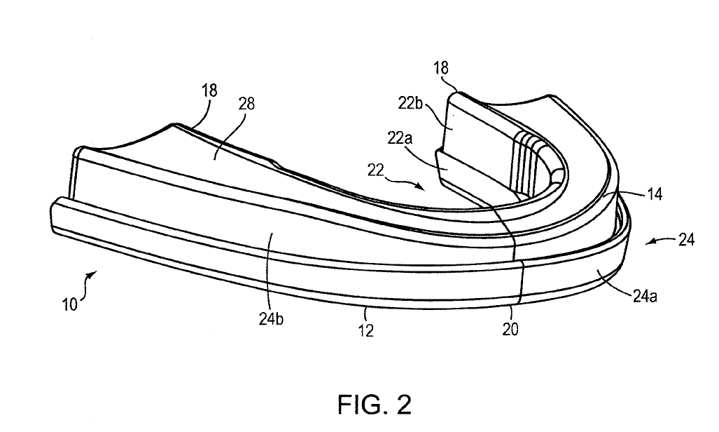

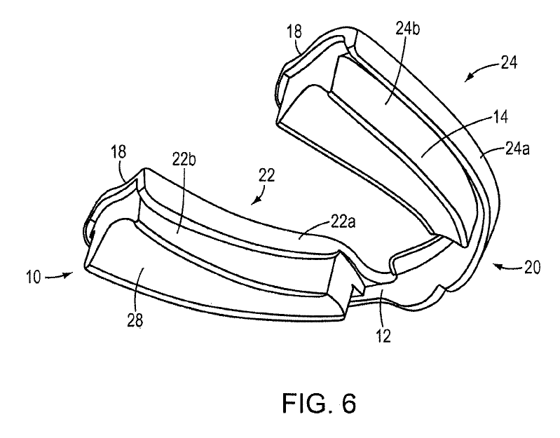

The dental appliance 10 in one embodiment, FIG. 2 and FIG. 6, includes a bite tray 12 and a formable portion 14 that is disposed within the bite tray 12. The bite tray 12 and the formable portion 14 can be made from one or more biocompatible materials, such as, for example, a biocompatible thermoplastic. The appliance 10 can be formed in a U-shape and include opposing first posterior and second posterior sections 18 configured to be positioned between the upper and lower molars, or posterior teeth, of the wearer. The appliance 10 can also include an anterior section 20 disposed between the first and second posterior sections having an arcuate curvature. The dental appliance can include a lingual edge side 22 and a buccal edge side 24. The lingual edge side 22 is closest to the tongue (not shown) of the wearer when the appliance is placed in the mouth. The buccal edge side 24 is closest to the cheek when the appliance is placed in the mouth. The buccal wall or the buccal edge can also be known as the facial wall. In some embodiments, the dental appliance also includes a formable bite surface 28 which is the contact surface of the formable portion 14, for contact with, for example, the upper teeth of the wearer and a bite surface (not shown) of the bite tray 12 for contact with, for example, the lower teeth of the wearer. In some embodiments, the formable bite surface 28 is adapted for contact with the lower teeth, and the bite surface can be adapted for contact with the upper teeth.

Preferably, the bite tray is formed by injection molding a first thermoplastic resin into a base mold cavity. The bite tray can be injection molded from a thermoplastic material having a Vicat softening temperature of at least about 65 degree C., which is significantly higher than the temperature to which the appliance is raised during the fitting procedure. In some embodiments, the base member is formed from an ethylene methyl acrylate copolymer, such as Elvaloy® 1209 (70 degrees C. Vicat softening point, 98 Shore A hardness) or Elvaloy® 1609 (70 degree C. Vicat softening point, 97 Shore A hardness), both of which are manufactured by DuPont™.

In an alternative embodiment, the bite tray can be formed from a 50-50 blend of Dupont™ Elvax® 750, which is an ethylene vinyl acetate (EVA) copolymer, and Pellethane® 2103-70A, which is a thermoplastic polyurethane elastomer (TPU). (This yields a material with a 75.3 Degree C. Vicat softening and a Shore hardness of 83.5). In yet another embodiment, the bite tray 12 can be formed from a non-blended EVA material, such as DuPont™ Elvax® 470 (68 degree C. Vicat softening temperature, 90 Shore A hardness, 18% vinyl acetate) or DuPont™ Elvax® 650Q (65 degree C. Vicat softening temperature, 93 Shore A hardness, 12% vinyl acetate). In these alternative embodiments, the hardness of the bite tray 12 can be decreased by increasing the percentage of TPU, such as Pellethane® 2103-70A (75.6 degree C. Vicat softening temperature, 72 Shore A hardness) or the hardness can be increased by addition of a polyethylene (PE) material.

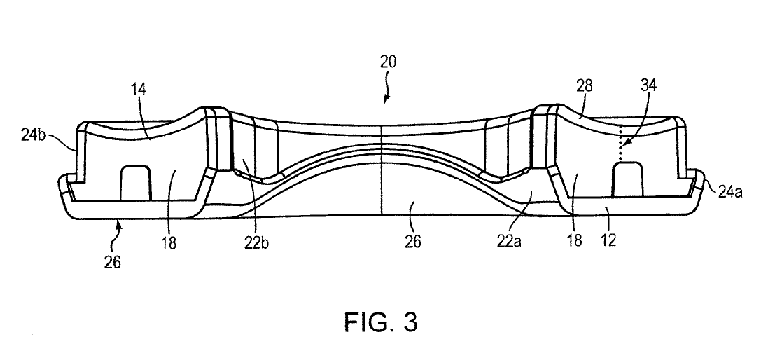

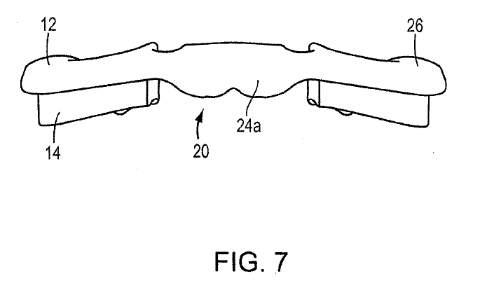

The bite tray can include opposing first posterior tray section and second posterior tray section configured to be positioned between the upper and lower molars of the wearer. In one embodiment, FIG. 3, when the dental appliance is placed in the wearer's mouth, the lower teeth of the wearer can contact the bite surface 26, and the formable portion 14 is adapted to register the upper teeth of the wearer. An appliance adapted to register the upper teeth can also be referred to as an upper dental appliance. In some embodiments, FIG. 7, when the appliance is placed in the wearer's mouth, the wearer's upper teeth contact the bite surface 26, and the formable portion 14 is adapted to register the lower teeth of the wearer. An appliance adapted to register the lower teeth can also be referred to as a lower dental appliance.

In some embodiments, FIG. 3, the lingual tray edge 22a, the bite surface 26, and the buccal tray edge 24a of the bite tray 12 can form a rigid structure around the formable portion of the appliance such that the wearer can handle the appliance both during routine use and during the initial forming of the formable portion.

The bite surface 26 contacts the upper or lower teeth of the wearer when the dental appliance is worn to protect the wearer's teeth from the effects of bruxism. In some embodiments, FIG. 3, the bite tray 12 can include a lingual tray edge 22a which is disposed adjacent the bite surface 26. The bite tray can also include a buccal tray edge 24a that is adjacent the bite surface 26. In some embodiments the bite surface 26 is disposed between the lingual edge 22a and the buccal edge 24a. In some embodiments the anterior section of the dental appliance includes a bite surface 26 and a buccal edge 24a while the posterior section includes a lingual edge 22a, a buccal edge 24a, and a bite surface 26.

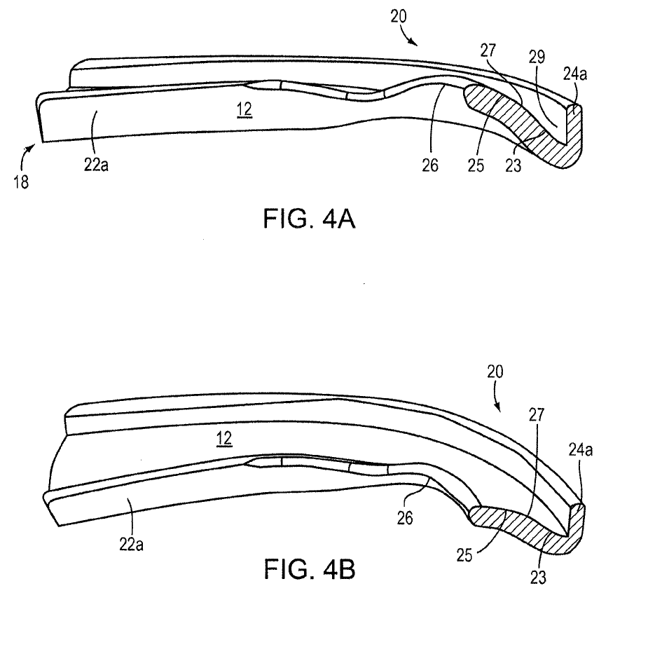

The anterior section 20 of the upper dental appliance, FIGS. 4a and 4b, can be formed without a lingual edge. In some embodiments, the bite surface 26 is contoured to form the opposing side of the anterior valley 29 with the buccal edge 24a of the bite tray 12. In some embodiments (not shown), the valley can be formed by the lingual edge, the bite surface, and the buccal edge.

The height of the buccal edge 24a of the anterior section 20 of the bite tray 12 can be selected such that the buccal edge 24a acts as a retaining wall which causes the formable portion (not shown) to pinch the center, anterior teeth of the user during registration. In some embodiments, the buccal edge can cause the formable portion (not shown) to pinch the incisal edge of the anterior teeth. In some embodiments, the height of the anterior buccal edge is about 2-4 mm. In some embodiments, the height of the anterior buccal edge is about 4-6 mm. Subsequently, after the wearer's teeth are registered in the formable portion of the dental appliance, the buccal edge of the anterior formable portion acts as a continuing retention point which assists in consistent fit during use.

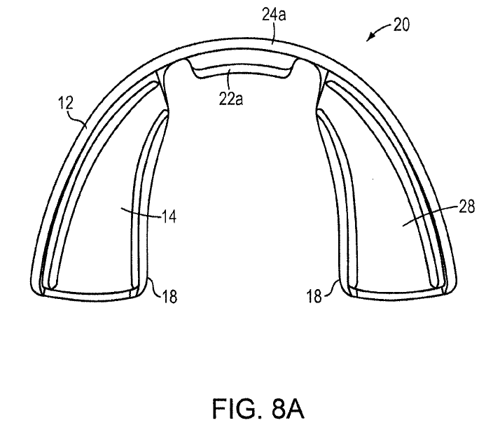

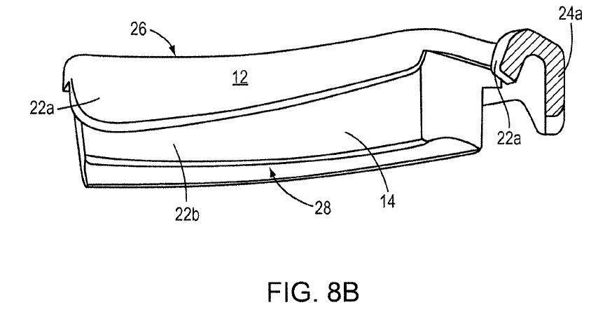

In some embodiments, FIG. 7, the height and/or shape of the anterior buccal edge 24a of a lower dental appliance can be selected to ensure retention of the dental appliance during initial teeth registration and subsequent use of the dental appliance. In some embodiments, FIGS. 8a and 8b, the lingual edge 22a of a bite tray can be adapted to ensure retention of the dental guard on the lower anterior teeth during initial fitting and registration of the teeth. In some embodiments, the lingual edge 22a in the anterior section 20 is adapted to prevent the lower dental appliance from shifting forward or away from the posterior teeth during initial registration of the wearer's teeth. The lingual edge 22a in the anterior section 20 can also be temporary and can be removed once the registration of the user's teeth is made in the formable portion 14 of the dental appliance. If the anterior lingual edge is removed, only the buccal edge of the bite tray remains in the anterior section of the dental appliance. This can be advantageous because users are more likely to dislodge the dental guard with their tongue if a lingual edge remains on the anterior section after the initial registration.

In some embodiments, FIGS. 4a and 4b, an anterior section 20 of the bite tray 12 of an upper dental appliance can form a contoured shape or form a ramp-like feature. In some embodiments the bite surface 26 or the lingual edge 22a forms the contoured ramp. In some embodiments, FIGS. 4a and 4b, the contoured shape of the bite tray 12 is formed such that the bite surface 26 and the buccal edge 24a of the bite tray 12 are disposed at less than 90° to form a valley 29 in the anterior section 20. The valley can also be formed by the lingual edge, the bite surface, and the buccal edge. The valley can be formed such that at least a portion of the valley, or an edge forming the valley, reflects the shape of the glenoid fossa. In some embodiments, the bite surface 26 is formed to reflect the shape of the glenoid fossa. In some embodiments, the surface of the valley in the anterior section can also be formed to include a concave curvilinear surface 23, a convex curvilinear surface 25, and a tangential portion 27 positioned in between. In some embodiments, the lingual edge 22a (not shown) or the bite surface 26 of the anterior section is formed to reflect the glenoid fossa. The valley 29 can be tapered or U-shaped. In some embodiments the valley 29 has a curvilinear profile or surface. The valley can be formed such that the height of the lingual side of the valley is about 3-5 mm from the plane of the posterior bite surface. The valley can be formed such that the height of the lingual side of the valley is about 5-7 mm from the plane of the posterior bite surface. In some embodiments, the height of the lingual side of the valley is about 7-9 mm from the plane of the posterior bite surface. The anterior section of the bite tray can also be formed such that the wearer's lower anterior teeth do not contact the bite tray when the wearer grinds or clenches their teeth. In some embodiments, the anterior portion of the bite tray is formed such that the wearer's lower teeth do not traumatically contact the bite tray when the wearer grinds or clenches their teeth. Traumatic contact can be understood to mean contact that causes noticeable or permanent damage to the wearer's teeth if withstood for a period of time. The anterior section of the bite surface can also be formed such that less force is exerted between the upper and lower anterior teeth. In some embodiments, the contoured shape of the bite tray can be formed such that any load generated by the grinding and clenching can be shifted from the anterior teeth to the posterior teeth, which are better able to absorb the vertical load. Furthermore, the contour of the bite surface or the anterior section of the bite tray can be formed such that the wearer's teeth and jaw are aligned in an anatomically correct positioning, thereby allowing for a more comfortable fit during use.

In the upper or lower dental appliances, the bite surface of the posterior section of the bite tray can be formed to match the curvature of the wearer's occlusal alignment, that is to reflect the curve of Wilson and/or the curve of Spee. The posterior sections of the bite tray can also be adapted to conform to a lingual inclination of the lower posterior teeth. The posterior section can also be adapted to conform to a buccal inclination of the upper posterior teeth.

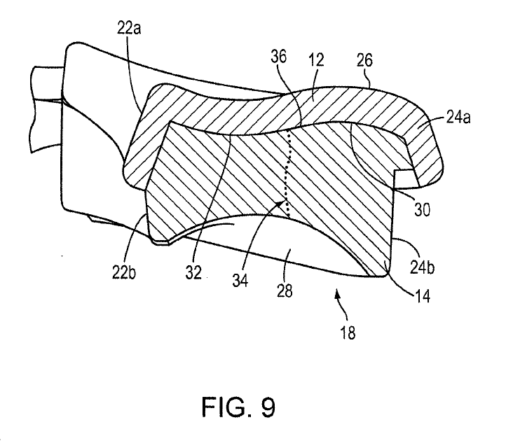

In some embodiments, the bite tray, including one or more of the lingual edge, the bite surface, and the buccal edge, can be formed to reflect the curve of Wilson and/or the curve of Spee. For example, the bite tray can be formed to reflect a prevalent curvature of the maxilla when the dental appliance is configured to register the upper teeth and the bite tray can be formed to reflect a prevalent curvature of the mandible when the dental appliance is configured to register the lower teeth. In some embodiments, FIG. 9, the posterior section 18 of the bite tray 12 can be formed to include a concave curvilinear surface 30, convex curvilinear surface 32, and a tangential connection surface 36 disposed between the convex and concave curvilinear surfaces. The curvilinear surface of the posterior sections 18 of the bite tray 12 is adapted to more closely reflect the curve of Wilson. For example, the lower dental appliance can be adapted to reflect the curve of Wilson as found in a prevalent occlusal alignment where the buccal cusps of the lower molars will be higher than the lingual cusps of the lower molars. The curve of Wilson can be reflected in the bite tray by an inclination from the buccal edge to the lingual edge, by the incorporation of a curvilinear surface, or by a combination of both. In some embodiments only the bite surface is adapted to reflect the curve of Wilson. In these lower dental appliances, the bite surface can include a concave curvilinear surface 30 that is adjacent to the buccal edge 24a and a convex curvilinear surface 32 adjacent to the lingual edge 22a. Alternatively, in an upper dental appliance the bite surface can include a concave curvilinear surface adjacent to the lingual edge and a convex curvilinear surface adjacent to the buccal edge. In some embodiments the curvilinear surface of the bite tray for an upper dental appliance can be adapted to reflect the curve of Wilson as found in a prevalent occlusal alignment. For the upper dental appliance, the curvilinear surface can be formed to reflect the curve of Wilson as found in a prevalent occlusal alignment where the lingual cusp of a molar is higher than the buccal cusp of the molar. Similar to the lower dental appliance, the curve of Wilson can be reflected in the bite tray by an inclination of the bite tray from the buccal edge to the lingual edge, by the incorporation of a curvilinear surface, or by both. In some embodiments, the curve of Wilson is only reflected in the configuration of the bite surface.

In some embodiments the bite tray prevents occlusion of the upper and lower teeth. Preventing occlusion can also reduce stress on the TMJ because the wearer's teeth and jaw are in an anatomically corrected position, thereby allowing the muscles of mastication to rest, thereby relieving the trauma on the TMJ and jaw muscles.

A formable portion can be disposed within the bite tray. In one aspect, the formable portion is customized or customizable for a user. According to one embodiment, the formable portion is formed, molded or moldable to custom-fit the registration of the wearer's upper teeth. One method of shaping the formable portion to custom-fit the registration of the wearer's teeth is sometimes referred to as boil-and-bite. Boil-and-bite methods are often used by individuals as a home-use technique. In the boil-and-bite method, the user heats the dental appliance by placing it in boiling water. The temperature of the boiling water is high enough to make the formable portion malleable so that the user's teeth are registered in the formable portion, but the bite tray is not sufficiently softened at the boiling temperature and therefore does not register the shape of the user's teeth. In some embodiments, the bite tray is sufficiently heated such that the shape of the bite tray is malleable enough to be configured to reflect the occlusal curvature of the user, including the curve of Wilson and/or the curve of Spee, but retains enough rigidity such that the impression of the user's teeth is not registered in the bite plate. In some embodiments, the formable portion is formed, molded or moldable to custom-fit the registration of the lower teeth or the upper teeth. The formable portion can be custom-formed or molded during the manufacturing of the devices based on molds or casts of the intended-user's upper or lower teeth. In some embodiments, the dental appliance can be custom-molded post-manufacturing by a medical or dental professional. The dental appliance can also be custom-molded by the user.

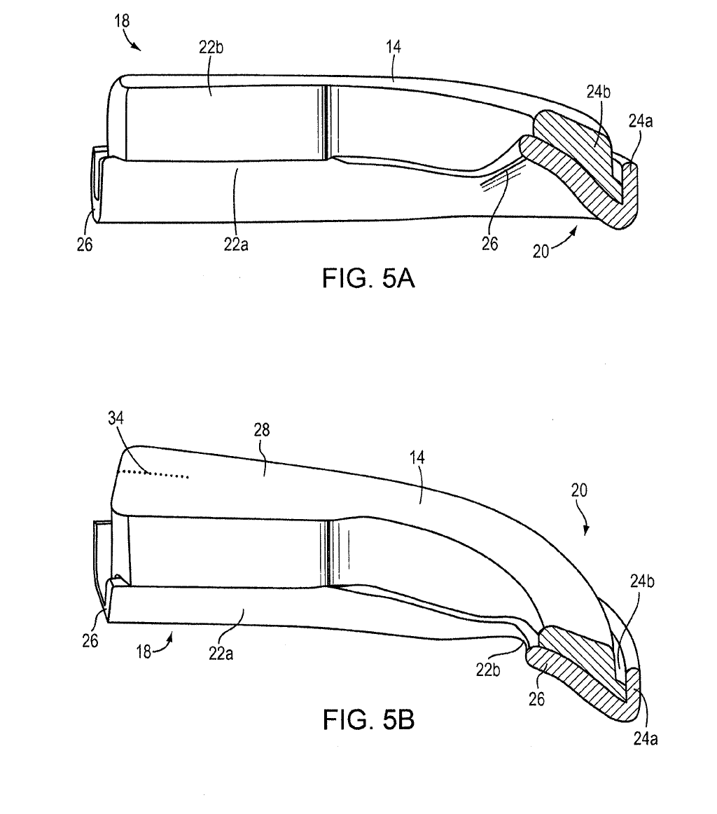

In some embodiments, FIGS. 2 and 6, the formable portion 14 include a lingual edge 22b and a buccal edge 24b. The formable portion can also include a formable bite surface 28 for registering the upper or lower teeth of the wearer. The formable bite surface can be inclined towards or away from the buccal edge. In some embodiments, FIG. 3, the posterior section of the formable bite surface 28 is inclined from the lingual edge 22b to the buccal edge 24b in the posterior section. In some embodiments, the height of the anterior buccal edge 24b of the formable portion 14 is about 5-7 mm above the plane of the bite surface. In some embodiments, the height of the anterior lingual edge 22b of the formable portion is about 8-10 mm above the plane of the bite surface 26. In some embodiments, the thickness of the formable portion is thicker in the posterior section than the anterior section. The increased thickness of the formable portion in the posterior section helps the initial registration of the teeth in the formable portion. If the anterior section 20 of the formable portion 14 is not as thick as the formable portion 14 in the posterior section 18, see e.g., FIGS. 5a and 5b, when the initial impression of the wearer's upper teeth is registered in the formable portion 14, the wearer's molars first contact the formable bite surface 28, and then the wearer's anterior teeth contact the anterior formable portion. The initial sequence of teeth contacting the formable portion is important because if anterior upper teeth contact the formable bite surface 28 first, the posterior occlusal surface is oriented or rotated away from the molars, which distorts the registration of the molars in the dental guard. This distortion often results in an uncomfortable dental guard and less than optimal compliance by the user. In some embodiments, the formable portion in the anterior section of the dental appliance will be inclined from the lingual edge 22b to the buccal edge 24b. This inclination of the anterior formable portion helps to distribute the proper amount of formable portion in the anterior section of the dental appliance, further assisting the proper and comfortable fit of the dental guard.

Initial registration of the upper teeth can also be made more predictable by the formable bite surface 28 having a concave contoured surface. In some embodiments, the concave contour will only be found in the posterior section of the formable portion 14. In some embodiments, FIG. 3, the concave contour will be further defined by the formable portion 14 being thicker at the lingual edge 22b than at the buccal edge 24b in the posterior sections. In some embodiments, the formable bite surface will not have a concave contour, but the posterior sections of the formable portion can be thicker on the lingual edge than at the buccal edge.

A higher lingual edge of the unformed formable bite surface can both cause the lingual cusp of the first upper molar to contact the bite surface properly, but can also ensure that enough of the formable material is retained on the lingual side of the upper dental appliance. In some embodiments, the increased thickness of the lingual edge of the formable bite surface can improve the retention of the dental appliance in the user's mouth by providing sufficient formable material on the lingual side of the upper posterior teeth after the dental appliance is customized.

In some embodiments the posterior section of the formable portion can be thicker than the anterior section of the formable portion. In some embodiments, the buccal edge is thicker than the lingual edge in the anterior section of the dental appliance, and in some embodiments, the lingual edge is thicker than the buccal edge in the posterior sections.

During the initial registration of the wearer's upper teeth in the formable portion 14, the lingual cusp of the upper molar is the first to contact the formable bite surface 28 when using one embodiment, e.g., FIG. 3, of the disclosed dental appliance. The concave contour of the formable bite surface 28 initially aligns the lingual cusp with the centerline 34 of the formable bite surface 28. As the tooth penetrates the formable portion 14, the tooth migrates towards the lingual edge 22a of the bite tray 12, however, because of the initial central alignment of the molar in relation to the bite tray 12, when the tooth penetrates the formable portion it is oriented properly in relation to the dental appliance. Absent the concave contour of the formable bite surface, the tooth could be aligned at any position along the posterior section of the formable bite surface and subsequently migrate over the lingual edge of bite tray. If the user's teeth align outside the profile of the bite tray, the effectiveness of the dental appliance is nullified.

In some embodiments, FIG. 8b, the anterior section of the formable portion of a lower dental appliance is thicker than the posterior sections of the formable portion. In some embodiments the posterior section of the formable portion is thicker than the anterior section of the formable portion. In some embodiments, FIG. 9, the buccal edge 24b of the formable portion 14 can be thicker than the lingual edge 22a of the formable portion 14 in the posterior section 18 of the dental appliance. A higher buccal edge 24b of the unformed formable bite surface 28 can both cause the buccal cusp of the first lower molar to contact the bite surface properly, but also ensure that enough of the formable material is retained on the buccal side of the lower dental appliance. In some embodiments, the increased thickness of the buccal edge 24b of the formable bite surface 28 can improve the retention of the dental appliance in the user's mouth by providing sufficient formable material on the buccal side of the lower posterior teeth after the dental appliance is customized.

In some embodiments of the lower dental appliance, FIG. 9, the alignment of the buccal cusp on a posterior tooth can also be facilitated by the concave contour of the formable bite surface 28. When the lower molars penetrate the formable portion 14 of the dental appliance, the tooth migrates towards the buccal edge 24a of the bite tray. The concave contour of the lower dental appliance aligns the lower molar cusp with the centerline 34 of the lower dental appliance thereby facilitating proper registration of the wearer's teeth in the formable portion.

The dental appliance can be manufactured using a two stage injection process or a bi-injection process. In a two stage injection process the bite tray can be placed into a second mold cavity into which is injected a second thermoplastic resin that bonds to the bite tray and forms the formable portion. In a bi-injection process the bite tray remains in the original mold or die, into which is injected a second thermoplastic resin that bonds to the bite tray and forms the formable portion. In one embodiment the formable portion can be formed from a resin comprising a mixture of two ethylene vinyl acetate (EVA) copolymers: AT Plastics Ateva® 4030 (40% vinyl acetate) and Elvax® 150 (33 32% vinyl acetate). The formable portion of the dental appliance can be injection molded from a thermoplastic material having a Vicat softening temperature of less than about 46 degrees Celsius, which is lower than the temperature, to which the appliance is raised during the fitting procedure. The formable portion can also be formed from a material comprising at least about 35% vinyl acetate (by weight). For example, the formable portion may be formed from one or more of the following ethylene vinyl acetate (EVA) materials: DuPont™ Elvax® 150 (36 degree C. Vicat softening point, 73 Shore A hardness, 32% vinyl acetate); Ateva® 3325AC (68 Shore A hardness, 33% vinyl acetate); Ateva® 2604A (46 degree C. Vicat softening point, 84 Shore A hardness, 26% vinyl acetate); and Elvax® 240 (40 degree C. Vicat softening point, 78 Shore A hardness, 28% vinyl acetate).

To custom fit the appliance to the teeth and gums of the wearer, the appliance is first immersed in boiling water for about 60 seconds so that the thermoplastic material of the formable portion reaches a temperature that is above its softening temperature. The appliance is then inserted into and symmetrically aligned within the oral cavity so that all of the wearer's teeth are aligned with the appliance. The wearer next applies firm pressure to seat the upper molars on the formable bite surface, and then applies biting pressure to imbed the molars into the formable bite surface and then the anterior teeth into the bite surface of the anterior section of the appliance. The biting pressure causes little, if any, deformation of the material of the bite tray because the softening temperature of the bite tray material is not reached during the heating step. Using his/her fingers, the wearer can press in along the gum line on both sides of the appliance from the front to the rear using equal amounts of pressure. This forms the softened formable portion material up and around the wearer's teeth. The wearer can also suck in to remove excess moisture and create a suction that allows the appliance to stay in place comfortably. Once the wearer feels that a comfortable fit has been achieved, the appliance can be placed in a container of cold water for about 30 seconds to “set” the formable portion material. Upon cooling, the material of the formable portion retains the impression or registration of the wearer's upper teeth. The result is a custom-fitted reusable dental appliance that may be comfortably worn during sleep to prevent bruxism and clenching.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A dental appliance comprising:
a bite tray comprising:
opposing first and second posterior sections for positioning between upper and lower posterior teeth of the wearer wherein the posterior sections include a concave curvilinear surface, a convex curvilinear surface, and a tangential portion disposed between the concave curvilinear surface and the convex curvilinear surface;
an anterior section disposed between the first posterior section and the second posterior section.

2. The dental appliance of claim 1 further comprising a formable portion disposed adjacent the bite tray.

3. The dental appliance of claim 2 wherein the formable portion is adapted to register the lower teeth of a wearer and the bite tray is adapted to contact upper teeth of the wearer.

4. The dental appliance of claim 1 wherein the bite tray accommodates a curve of Wilson.

5. The dental appliance of claim 1 wherein the bite tray accommodates a curve of Spee.

6. The dental appliance of claim 1 wherein the anterior section is adapted to prevent upper anterior teeth of the wearer from traumatically contacting the anterior section.

7. The dental appliance of claim 2 wherein the formable portion is disposed adjacent the first and second posterior sections of the bite tray.

8. The dental appliance of claim 2 wherein the posterior sections of the formable portion further comprise a formable bite surface having a concave curvature.

9. A dental appliance comprising:
a bite tray including a bite surface adapted to contact upper teeth of a wearer; and
a formable portion disposed within the bite tray adapted to register lower teeth of a wearer, the formable portion comprising:
opposing first and second posterior formable sections for positioning between upper and lower posterior teeth, the posterior formable sections having a formable bite surface with a concave contour.

10. The dental appliance of claim 9 wherein the posterior sections of the formable portion further comprises a buccal edge thickness and a lingual edge thickness wherein the buccal edge thickness is greater than the lingual edge thickness.

11. The dental appliance of claim 9 wherein the concave contour of the formable bite surface is adapted to align a buccal cusp of a lower posterior tooth with a centerline of the formable bite surface.

12. The appliance of claim 10 wherein the formable bite surface is configured to adapt to a lingual inclination of the lower posterior tooth.

13. The appliance of claim 10 wherein the bite tray conforms to a buccal inclination of an upper posterior tooth.

14. A method of manufacturing a dental appliance, the method comprising:
forming a bite tray having opposing first and second posterior sections for positioning between upper and lower posterior teeth of the wearer and an anterior section disposed between the first posterior section and the second posterior section, the posterior sections having a concave curvilinear surface, a convex curvilinear surface, and a tangential portion between the concave and convex surfaces.

15. The method of claim 14 further comprising forming a formable portion within the bite tray.

16. The method of claim 15 wherein forming the formable portion comprises forming formable posterior sections having a concave curvature.

17. The method of claim 15 wherein forming the formable portion further comprises forming formable posterior sections having a lingual edge and a buccal edge, wherein the buccal edge is thicker than the lingual edge.

18. A dental appliance comprising:
a bite tray comprising:
opposing first and second posterior sections for positioning between upper and lower posterior teeth of the wearer;
an anterior section disposed between the first posterior section and the second posterior section, the anterior section having a removable anterior edge.

19. The dental appliance of claim 18 wherein the removable anterior edge is adapted to retain lower anterior teeth of a user during fitting of the dental appliance.

20. The dental appliance of claim 18 wherein the removable anterior edge can be removed before or after fitting of the dental appliance.
